(19) United States
(12) Patent Application Publication
(10) Pub. No.: US 2016/0367026 A1
(43) Pub. Date: Dec. 22, 2016

(54) Rotatable Storage Device

(71) Applicant: Glideware, LLC, Grand Junction, CO (US)

(72) Inventors: David Hall, Grand Junction, CO (US); Jenny L. Hall, Grand Junction, CO (US)

(73) Assignee: Glideware, LLC, Grand Junction, CO (US)

(21) Appl. No.: 15/257,523

(22) Filed: Sep. 6, 2016

Related U.S. Application Data
(63) Continuation-in-part of application No. 14/679,433, filed on Apr. 6, 2015, now Pat. No. 9,433,283.
Application No. 14/679,433 is a continuation of application No. 14/285,258, filed on May 22, 2014, now Pat. No. 9,022,237.
Application No. 14/285,258 is a continuation-in-part of application No. 29/491,483, filed on May 21, 2014, now abandoned.
(60) Provisional application No. 62/242,128, filed on Oct. 15, 2015.
(60) Provisional application No. 61/826,408, filed on May 22, 2013.

(51) Int. Cl. A47B 49/00; F16B 45/00; A47J 47/16; A47B 77/14; A47B 81/00

(52) U.S. Cl. CPC A47B 49/00; A47B 77/14; A47B 81/002; A47J 47/16; F16B 45/00

(57) ABSTRACT

A storage device comprising a support element attached to a vertical element, the support element including a slot. The slot is accessible from a top surface of the support element and provides a surface to support at least one hook. The hook extends through the slot and below the bottom surface of the support element. The hook provides an interface for hanging and storing an item from the storage device. The storage device may be adapted to rotate within a corner cabinet or be interconnected to a door of a cabinet.

### CROSS-REFERENCE TO RELATED APPLICATIONS

This application claims the benefit of priority under 35 U.S.C. §119(e) to U.S. Provisional Patent Application Ser. No. 62/242,128, filed Oct. 15, 2015 and is a continuation-in-part of U.S. patent application Ser. No. 14/679,433, filed Apr. 6, 2015, now U.S. Pat. No. 9,433,283 on Sep. 6, 2016, which is a continuation of U.S. patent application Ser. No. 14/285,258, filed May 22, 2014, now U.S. Pat. No. 9,022,237, which is a continuation-in-part of U.S. patent application Ser. No. 29/491,483, filed May 21, 2014, and which claims the benefit of priority under 35 U.S.C. §119(e) to U.S. Provisional Patent Application Ser. No. 61/826,408, filed May 22, 2013. The entire contents of each of the foregoing applications are incorporated herein by reference in their entirety.

### FIELD

The disclosure relates to a storage device for hanging items from a rotatable support that may be attached to a vertical support. More specifically, the present disclosure generally relates to a storage device with a rotatable support element that includes at least one slot adapted to receive hooks to hang objects. The hooks may be moved and repositioned in the slot without disassembling the storage device.

### BACKGROUND

A large number of items of cookware are frequently used in kitchens. The cookware can be of various sizes and types. Cooks generally prefer to have their cookware stored neatly where the cookware is easily accessible for use. However, kitchens generally have only a limited amount of storage space available. As a result, storing cookware efficiently without wasting storage space is a recurring problem. The storage problem is made more difficult because many types of cookware have delicate cooking surfaces or exteriors that are easily damaged or marred.

One method of storing cookware involves hanging pieces of cookware from racks that hang from a ceiling or wall. Pieces of cookware are also frequently hung from hooks attached to various surfaces including the inside of cabinet doors. Cookware is also often stacked on shelves or in deep drawers. Corner cabinets are also used to store cookware.

These methods of storing cookware have several shortcomings. Stacking cookware makes it difficult to retrieve a needed piece of cookware. When cookware is stacked it is hard to view an entire cookware collection to select the best piece of cookware for the task at hand. A needed piece of cookware can be difficult to locate because the needed piece may be hidden in the stack by unneeded pieces. Unneeded pieces of cookware must frequently be lifted and unstacked to reach the needed piece. It is especially difficult to find cookware stored in corner cabinets, including those with rotating shelves, because corner cabinets are frequently deeper than other cabinets but have only a relatively narrow opening. After using a needed piece of cookware, other pieces of cookware must be moved again to return the needed piece to the stack. Additionally, stacking and unstacking cookware can damage cookware pieces with non-stick or decorative surfaces as the pieces bump and rub against each other. Because of this, many cookware manufacturers recommend against stacking cookware with decorative or non-stick surfaces.

Hanging cookware from ceiling or wall racks also creates several problems. Dust and contaminates can accumulate on cookware hung in the open from ceiling and wall racks. Additionally, many consumers either lack the space for overhead or wall storage, or find these methods of storing cookware interfere with their movement in the kitchen. Ceiling racks can also allow items of cookware to bump against each other making noise and potentially damaging the cookware.

Consumers who have sufficient space for overhead or wall storage methods frequently cannot reach a ceiling rack or a wall rack without an assistive device, or feel doing so is unsafe. Because some items of cookware are heavy or large, it is also difficult for many consumers to lift the cookware high enough to reach the ceiling rack or wall rack. Further, some consumers avoid overhead and wall storage methods because they prefer a clean, clutter-free look to their kitchen, and thus prefer that all items of cookware are stored within cabinets when not in use.

Using hooks attached to cabinet doors causes several problems. Cabinet doors are frequently thin and do not provide a strong mounting surface for a hook, limiting the weight of cookware items that may be stored. Therefore, hanging items of cookware from hooks driven into a cabinet door is not a significant improvement over stacking.

Attempts have been made to overcome these storage, capacity, and damage problems with only limited success.

An extendable garment hanger is described in U.S. Pat. No. 1,132,190, which is incorporated herein by reference in its entirety. The garment hanger has a number of hooks spaced at fixed intervals on an extendable rack; however, the hooks cannot be moved or repositioned on the rack and additional hooks cannot easily be added to the rack.

A suspension device for clothing, curtains, and the like is generally described in U.S. Pat. No. 1,613,447, which is incorporated herein by reference in its entirety. The suspension device is attached under a shelf by two brackets. A hollow tubular rod with a longitudinal slot facing downward is held by the brackets. Hooks are inserted through an open end of the slot. The hooks are suspended from the slot and can slide length-wise along the slot. The open end of the slot is covered when the tubular rod is in position between the brackets and therefore it is not possible to insert or remove hooks without at least partially disassembling the device.

U.S. Pat. No. 1,814,692, which is incorporated herein by reference in its entirety, describes an extendable utensil rack comprising two telescoping tubular members, with the entire system mounted to the vertical wall of a cabinet. Hooks can only be added or removed by inserting them through the ends of the rack body before the rack is mounted to the wall or by detaching the rack body from the wall. In addition, mounting the rack to a vertical wall potentially limits the arrangement of pots and pans within the storage space, as the cookware is stored in relatively close proximity to the cabinet side-wall.

An example of a rotatable storage device is described by U.S. Pat. No. 1,864,039 which is incorporated herein by reference in its entirety. The '039 patent includes a round disc. In one embodiment, hooks are screwed into a lower portion of the disc for hanging objects. Thus, hooks can only be added to the disc my drilling into the disc. If a hook is removed, an unsightly hole will remain in the disc. In another embodiment, an upward facing groove is formed in the disc. Radial notches intersect the groove to receive stems of hangers. Accordingly, hangers may only be added to disc where the notches are present.

An extendable cup rack is described in U.S. Pat. No. 2,606,666, which is incorporated herein by reference in its entirety. The cup rack includes a plurality of support arms having hook portions at opposite ends. However, the support arms and hooks are fixedly and firmly attached at their mid-portions to a hanger of the cup rack, thereby preventing adjustment, arrangement, and addition of hooks to best support various pieces of cookware. Further, because the hooks extend outward, perpendicular to the longitudinal axis of the rack, the rack may twist or be damaged if heavier items are hung from the support arms on one side of the rack rather than on the other side of the rack.

A pot mounting apparatus is described in U.S. Pat. No. 2,608,305, which is incorporated herein by reference in its entirety. The apparatus comprises a slidable panel with a vertical orientation from which hooks are fixed for holding pots. The hooks are attached to the panel by screws and are therefore not easily adjusted without disassembling and reconfiguring the device. The apparatus also includes wire racks which include hairpin shaped slots for gripping pots which could damage or scratch surfaces of cookware.

U.S. Pat. No. 2,611,492, which is incorporated herein by reference in its entirety, describes a support for hanging articles. The support is attached to an under side of a shelf and includes a recess with a slot for holding a ball end of a hook. The recess is not accessible from the top. Instead, the support includes a port through which hooks can be added or removed, but the port faces downward making it difficult to align the ball end with the port.

An extendable closet rod is described in U.S. Pat. No. 2,757,804, which is incorporated herein by reference in its entirety. The closet rod includes a downward facing slot through which a hook of a hanger bracket extends. The slot is closed at the top. To add or remove a hanger bracket to the closet rod, an upper body portion of the bracket must be inserted through cutouts formed in a lower wall at the ends of the closet rod. Further, because hanger brackets can only be added through the cutouts, the order and arrangement of the hooks cannot be changed such that if a particular hanger bracket is damaged or requires replacement, several hanger brackets may first have to be removed before the particular hanger bracket can be removed.

A pivoting rack for utensils is described in U.S. Pat. No. 3,379,484, which is incorporated herein by reference in its entirety. The rack is secured within a kitchen cabinet by a vertical piano hinge. The rack includes pegboard panels that can swing out of a cabinet. However, cookware positioned between two of the panels is difficult to reach.

Another design for storing cookware is described in U.S. Patent Publication No. 2012/0211449, which is incorporated herein by reference in its entirety. This design comprises a horizontal rack assembly adapted to mount to slides within a cabinet. The rack includes two side bars and several cross bars. Hooks hang down from the rack for receiving pots and pans. Because of the width of this design, pots hanging from a center portion of the rack would be difficult to reach. Additionally, because the hooks can only be positioned from the side bars or cross bars, the lateral spacing and adjustment of the hooks is not possible.

A hanging rack for items is describe in U.S. Pat. No. 8,998,010 which is incorporated herein in its entirety. The rack includes a plurality of hooks suspended from tiers of the rack.

Another hanging rack for pots is illustrated in U.S. Design Pat. D392,133 which is incorporated herein in its entirety. This design includes a horizontal rack adapted to be suspended from chains. Hooks hang down from the rack for receiving pots.

Several designs include movable or telescoping members with downwardly hanging hooks for cookware. Examples are provided in U.S. Pat. No. 6,227,387, U.S. Pat. No. 6,976,595, and U.S. Patent Application Publication No. 2011/0000864, which are each incorporated herein by reference in their entirety. However, these designs do not allow the user to easily remove and/or add the hooks.

A rotating implement holder is described in U.S. Pat. No. 6,273,277 the disclosure of which is incorporated in its entirety herein. The holder is suspended from a support and includes a carousel with a rim and spokes. A plurality of hooks are fixedly attached around the rim and to the spokes. Accordingly, the position of the hooks cannot be adjusted by a user.

Another rotating article holder is generally described in U.S. Pat. No. 7,451,882 which is incorporated in its entirety herein. The article holder includes a shaft with individually rotatable storage units. The storage units include hooks from which items may be suspended.

Free standing pot supports are described in U.S. Pat. Nos. 5,765,700 and 5,833,080 which are each incorporated herein by reference in their entirety. Both of these designs include hooks arranged around a periphery of each of the supports.

An adjustable assembly for hanging cookware is described in U.S. Pat. No. 7,766,290, which is incorporated herein in its entirety. The adjustable assembly includes a hanger track. Hanger assemblies rest on the hanger track from hanger sliders. Although the hanger assemblies can rotate and slide freely along the hanger track, the track ends must be removed to add hanger assemblies to the hanger track. Further, because hanger assemblies can only be removed from the track ends, if a hanger assembly is damaged and an undamaged hanger assembly is positioned between the damaged hanger assembly and the end, the undamaged hanger assembly must be removed before the damaged hanger assembly can be removed.

A rotary storage device for a corner cabinet is described in U.S. Pat. No. 8,074,812 which is also incorporated herein in its entirety. The device includes a hanging track enclosed by a track clamp. Both the track and the track clamp have an opening or slot facing downward and hooks project through the slot. However, the track and track clamp are both closed at the top. Therefore, additional hooks may only be added by feeding the hooks through the ends of the track and track clamp. By using this design, if a user wants to add a different type of hook in a particular position, other hooks may have to be removed and then reinserted into the track to achieve the desired arrangement.

U.S. Patent Application Publication No. 2013/0099073, which is incorporated herein by reference in its entirety, describes a retractable hanging assembly for cookware. The hanger assembly includes a hanger track section with a closed top and a track slot formed facing downward. Hanger assemblies are coupled to the hanger track section and cannot be added through the closed top of the hanger assembly.

Accordingly, there is an unmet need for a storage device that increases efficiency of storage space through the ability to provide improved access to stored items and which provides an improved ability to add or remove hooks without disassembly or removal of the storage device from the storage space and without first removing other hooks from the storage device.

### SUMMARY

This disclosure provides a novel storage device that has a slot through a rotatable support element of the storage device. Hooks can be added to, and removed from, the storage device by inserting the hooks through the slot from a top side of the support element. Thus, the arrangement, position, and number of hooks associated with the storage device can be adjusted to most efficiently use available storage space without disassembly of the storage device, without removing the storage device from a surface or support to which the storage device is attached, and without first removing other hooks associated with the storage device.

One aspect of the present disclosure is to provide an improved and convenient method and device for the storage of cookware and other items so that the stored items are readily accessible for all potential users in a household, restaurant, or institution.

It is another aspect of the present disclosure to provide a storage system that is easily modified by the user to store different items. The storage system provides access to the system components such that a user can modify the system without disassembly of the system into its component pieces.

It is a further aspect of the present disclosure to allow for maximum utilization of storage space by providing a system that can be modified at will by the user to accommodate different shaped and sized items.

It is another aspect of the present disclosure to provide a system that allows easy access to all of the items being stored in the storage space, regardless of the stored item's position in the storage space (e.g. front, middle or back).

It is a further aspect of the present disclosure to provide a system that keeps items from contacting each other, or limits contact between the items. In this manner, the system minimizes damage to cookware surfaces and extends the life of the stored items. In one embodiment, the system comprises an arrester interconnected to a portion of a storage device. The arrester is adapted to engage a portion of an item, such as a handle, to decrease (or prevent) inadvertent or intended movement of the item. In one embodiment, the arrester includes a plurality of notches or grooves to engage the stored item.

It is another aspect of the present disclosure to provide a storage device that fits within an interior space of a closet or a storage cabinet in a first position but that can be rotated to extend at least partially from the interior space in a second position.

It is still another aspect of the present disclosure to provide hooks that can be added to, or removed from, the storage device without: disassembly of the storage device; removal of other hooks from the storage device; or alteration or drilling into the storage device. In one embodiment, when the hooks are interconnected to the storage device, the hooks are substantially stationary. In another embodiment, the orientation of the lower end of the hooks can be rotated about a vertical axis of the hooks before, or after, the hooks are interconnected to the storage device. Hooks of one or more types with different shapes and sizes can be used interchangeably to efficiently use limited storage space. In one embodiment, a base of the hook as one of a round, a square, a hexagonal, and an octagonal shape.

One aspect of the present disclosure is to provide a support element. The support element generally comprises, but is not limited to: (1) a top surface opposite a bottom surface; and (2) a slot formed through the support element and extending from the top surface through the bottom surface. In one embodiment, the slot includes a lower portion positioned below an upper portion. The lower portion of the slot has a width that is less than a width of the upper portion of the slot. In this manner, the slot is operable to receive at least one hook by inserting the at least one hook through the slot from a top side of the support element.

In one embodiment, the slot has a generally arcuate shape that is generally parallel to a radial edge of the support element. The slot may optionally include a first slot portion separated from a second slot portion by a bridge. In one embodiment, the bridge is substantially parallel to a radius of the support element. The bridge may optionally comprise a portion of the slot in which at least the slot lower portion is not formed. In another embodiment, the bridge may comprise an area where neither of the lower portion nor the upper portion of the slot are formed in the support element.

The support element may be suspended from a frame assembly. The frame assembly may comprise a substantially vertical element positioned within an enclosed space. In one embodiment, the frame assembly hangs downwardly from a substantially horizontal surface. In another embodiment, the frame assembly projects upward from a substantially horizontal surface. In still another embodiment, the frame assembly is positioned between two generally parallel surfaces. Optionally, the frame assembly may be interconnected to one or more of the two generally parallel surfaces.

Alternatively, the support element may be interconnected to a generally vertical element. For example, the support element may be interconnected to a vertical element such as, but not limited to, a door. In one embodiment, the support element is interconnect to an interior surface portion of a cabinet door.

The support element may have a variety of shapes. In one embodiment, the support element has a substantially semicircular shape. In another embodiment, the support element is generally circular. The generally circular support element may have a notch forming a void. Accordingly, in one embodiment, the exterior axial edge of the support element spans more than approximately 270 degrees. In another embodiment, the axial edge spans about 330 degrees. In one embodiment, in which the support element is interconnected to a door, the support element spans approximately 180 degrees. Other shapes are contemplated.

An arrester may be positioned a predetermined distance from the support element. In one embodiment, the arrester is positioned below the support element and is substantially parallel to the support element. Optionally, at least one notch may be formed in an outer axial edge of the arrester. The arrester may have a radius of between about 5 inches and about 9 inches.

One aspect of the present disclosure is to provide a storage device. The storage device generally comprises, but is not limited to: (1) a frame assembly oriented substantially vertically; and (2) a support element interconnected to the frame assembly. In one embodiment, the frame assembly may be adapted to be positioned within an enclosed space.

The support element generally includes a top surface opposite a bottom surface. The support element may be substantially round. A radius of the support element may optionally be from about 12 inches to about 16 inches, but other sizes are contemplated. In one embodiment, the support element is rotatably interconnected to the frame assembly. In another embodiment, at least a portion of the frame assembly is adapted to rotate with respect to another portion of the frame assembly. In this embodiment, the support element is fixedly interconnected to the rotatable portion of the frame assembly. In one embodiment, the support element if formed of wood. Optionally, the support element may be formed of a metal, a plastic, a wood, and a combination thereof.

At least one slot is formed through the support element and extends from the top surface through the bottom surface. The slot may comprise a lower portion positioned below an upper portion, the lower portion of the slot having a width that is less than a width of the upper portion of the slot. The slot is adapted to receive at least one hook by inserting the at least one hook through the slot from a top side of the support element.

Optionally, the slot may have a generally arcuate shape. In one embodiment, the slot is positioned substantially parallel to an outer axial edge of the support element. In this manner, the slots may be oriented generally axially. In one embodiment, the slot has a radius of from about 5 inches to about 9 inches.

In still another embodiment, the slot is generally parallel to a radius of the support element. Accordingly, in one embodiment, at least one of the support element includes at least one slot that is oriented generally radially.

The storage device may comprise two support elements. The two support elements may comprise an upper support element that is substantially parallel to a lower support element. Each support element may comprise at least one slot.

Optionally, the slot further comprises two ledges formed by a transition from the wider upper portion of the slot to the narrower lower portion of the slot. The width of the lower portion of the slot may be about 0.25 inch to about 0.75 inch. The width of the upper portion of the slot may be about 0.75 inch to about 1.25 inches.

In one embodiment, the slot includes a first slot portion at least partially separated from a second slot portion by a bridge. The bridge provides support for a radially outer portion of the support element. In one embodiment, the bridge is generally parallel to a radius of the support element. In another embodiment, the bridge comprises a portion of the slot in which the lower slot portion is not formed.

The support element may comprise two slots. In one embodiment, at least one of the two slots is oriented radially substantially parallel to a radius of the support element. In another embodiment, a first one of the two slots intersects a second one of the two slots. In still another embodiment, the two slots do not intersect. Accordingly, in one embodiment, the support element includes two substantially concentrically aligned slots.

An arrester may be interconnected to the frame assembly. In one embodiment, the arrester is positioned below the support element and is substantially parallel to the support element. Optionally, at least one notch may be formed in an outer axial edge of the arrester. The arrester may have a radius of between about 5 inches and about 9 inches. In one embodiment, the arrester is adapted to rotate when the support element rotates. A slot to receive at least one hook may optionally be formed in the arrestor. The slot of the arrester may have the same shape and cross-sectional profile of the slot formed in the support element.

In one embodiment, the support element includes a notch. In one embodiment, the notch comprises a first edge that is substantially parallel to a first radius. The first edge intersects a second edge that is substantially parallel to a second radius. Optionally, the first edge is generally perpendicular to the second edge.

Optionally, the support element may comprise one or more cutouts. Each cutout comprises an aperture formed through the support element. The cutouts may have any shape or size. In one embodiment, the cutouts have a size sufficient to be grasped by a user to rotate the support element.

In one embodiment, the frame assembly comprises: (i) an upper indexer adapted to be interconnected to an upper structure; (ii) a lower indexer adapted to be interconnected to a lower structure; (iii) a vertical support interconnected to the lower indexer; (iv) a riser interconnected to the upper indexer and the vertical support; and (v) a brace rotatably interconnected to the vertical support, the brace adapted to receive the support element.

In another embodiment, the frame assembly comprises: (i) an upper indexer adapted to be interconnected to an upper structure; (ii) a riser interconnected to the upper indexer, and (iii) a brace rotatably interconnected to the riser, the brace adapted to receive the support element.

It is another aspect of the present disclosure to provide a rotatable storage device. The rotatable storage device generally includes, but is not limited to: (1) a frame assembly oriented substantially vertically; (2) a support element interconnected to the frame assembly; and (3) an arrester interconnected to the frame assembly, the arrester being positioned below the support element. The support element generally includes a top surface opposite a bottom surface and a slot adapted to receive at least one hook. The slot is formed through the support element and extends from the top surface through the bottom surface. The slot includes a first slot portion separated from a second slot portion by a bridge. In one embodiment, the slot is substantially parallel to an outer axial edge of the support element. Optionally, an outer axial edge of the arrester has at least one notch.

In one embodiment, the slot comprises a lower portion positioned below an upper portion. The lower portion of the slot has a width that is less than a width of the upper portion of the slot. Optionally, the slot further comprises two ledges formed by a transition from the wider upper portion of the slot to the narrower lower portion of the slot. In one embodiment, the ledges are substantially parallel to the top surface of the support element. In another embodiment, the ledges are transverse to the top surface such that the ledges intersect the top surface. In one embodiment, the slot has a radius of from about 5 inches to about 9 inches. In another embodiment, the arrester has an exterior radius not greater than, the radius of the slot. In yet another embodiment, the arrester radius is between about 5 inches and about 9 inches.

In one embodiment, the bridge is aligned substantially parallel to a radius of the support element. The bridge may optionally comprise a portion of the slot in which at least the slot lower portion is not formed. In another embodiment, the bridge may comprise an area where neither of the lower portion nor the upper portion of the slot are formed in the support element.

In one embodiment, the support element is substantially round. Optionally, the support element may have a radius of from about 12 inches to about 16 inches.

Still another aspect of the present disclosure provides a support system. The support system comprises: (1) a support element that is interconnectable to a vertically oriented structure; and (2) an arrester that is interconnectable to the vertically oriented structure, the arrester adapted to be positioned a predetermined distance below the support element. In one embodiment, the vertically oriented structure is a door.

The support element generally includes a top surface opposite a bottom surface and a slot adapted to receive at least one hook. In one embodiment, the support element has an outer radial edge that is semi-circular. In another embodiment, the outer radial edge of the support element has a radius that is substantially uniform. In still another embodiment, the radius of the support element is not greater than one-half of a width of the vertically oriented structure.

The slot is formed through the support element and extends from the top surface through the bottom surface. The slot includes a first slot portion separated from a second slot portion by a bridge. In one embodiment, the slot is substantially parallel to an outer axial edge of the support element.

The arrester has an outer radial edge that is semi-circular. In one embodiment, the radius of the arrester outer radial edge is about equal to, and no greater than, a radius of the slot of the support element. Optionally, an outer radial edge of the arrester has at least one notch.

Another aspect of the present disclosure provides a hook for a storage device. The hook generally comprises at least one base. A shank extends down from a lower surface of the base. A lower end extends from the shank. The hook has a length of about 2 inches to about 8 inches. In one embodiment, the base has a width of about 0.445 inch to about 1.445 inches and a thickness of about 0.25 inch to about 0.5 inch. Optionally, the width and thickness of the base are selected such that the base fits within an upper portion of a support element slot without extending above a plane formed by a top surface of the support element.

In one embodiment, the base has a shape of one of a square, a rectangle, a circle, an oval, a polygon, a pentagon, a hexagon, an octagon, and combinations thereof. In another embodiment, the horizontal edges of the base have a radius of about 0.05 inch and the vertical edges of the base have a radius of about 0.1 inch. In still another embodiment, a horizontal cross section of the shank of the hook has a generally square shape with sides having a length of about 0.35 inch to about 0.41 inch. In yet another embodiment, the shank can rotate with respect to the base.

The hook may be formed of at least one of a wood, a plastic, and a metal. In one embodiment, the hook is formed monolithically as one integral piece without any individual components, joints, or necessity to interconnect additional elements. Optionally, the shank and the base of the hook may be formed of separate pieces that are interconnected together. In this manner, a user may select a base of a desired shape to interconnect to a base with a preferred shape and size.

In one embodiment, the hook includes two portions adapted to receive an item, a first lower end and a second lower end. The first lower end is positioned on an opposite side of the shank from the second lower end.

The above-described embodiments, objectives, and configurations are neither complete nor exhaustive. As will be appreciated, other embodiments are possible using, alone or in combination, one or more of the features set forth above or described in detail below.

This Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in this Summary as well as in the attached drawings and the Detailed Description and no limitation as to the scope of the present disclosure is intended by either the inclusion or non-inclusion of elements or components. Additional aspects of the present disclosure will become more readily apparent from the Detailed Description, particularly when taken together with the drawings.

### BRIEF DESCRIPTION OF DRAWINGS

The accompanying drawings are incorporated into and form a part of the specification to illustrate examples of the aspects, embodiments, or configurations disclosed herein. These drawings together with the description, explain the principle of the aspects, embodiments, or configurations. The drawings simply illustrate preferred and alternative examples of how the aspects, embodiments, or configurations can be made and used and are not to be construed as limiting the aspects, embodiments, or configurations to only the illustrated and described examples. Further features and advantages will become apparent from the following, more detailed, description of the various aspects, embodiments, or configurations, as illustrated by the drawings referenced below. Reference numbers are the same for those elements that are the same across different Figures.

FIG. 1 is a top perspective view of a storage device according to one embodiment of the present disclosure and illustrating a hook aligned for insertion in a slot of a support element;

FIG. 2 is a bottom perspective view of the storage device of FIG. 1 and illustrating the hook inserted within the slot with a lower end of the hook extending beyond a lower portion of the slot;

FIG. 3 is a top plan view of a rotatable support of the storage device of FIG. 1;

FIG. 4 is a bottom plan view of the rotatable support element of the storage device of FIG. 1;

FIG. 5 is a top cross-sectional perspective view of the rotatable support element of FIGS. 3-4;

FIG. 6 is a bottom plan view of another embodiment of a rotatable support element illustrating an optional boss that projects downwardly from a bottom surface of the support element;

FIG. 7A is a partial cross-sectional front elevation view of the rotatable support of FIG. 6 providing a detail view of a slot of one embodiment of the present disclosure;

FIG. 7B is partial cross-sectional front elevation view of a portion of a rotatable support element illustrating a slot of another embodiment of the present disclosure with a curved profile;

FIG. 7C is partial cross-sectional front elevation view of a rotatable support element illustrating a slot of an alternate embodiment of the present disclosure with an angled profile;

FIG. 8 is a top plan view of a rotatable support element according to another embodiment of the present disclosure including an axial slot and a plurality of radial slots;

FIG. 9 is another top plan view of another embodiment of a rotatable support element of the present disclosure including two axial slots substantially concentrically aligned, an outer one of the slots having a larger radius than an inner one of the slots;

FIG. 10 is yet another top plan view of a rotatable support element of another embodiment of the present disclosure including a plurality of radial slots;

FIG. 11 is a top plan view of a rotatable support element of still another embodiment of the present disclosure and further illustration hooks placed in an axial slot;

FIG. 12 is a cross-sectional view of the rotatable support element of FIG. 11 including hidden lines and a hook placed in the slot as well as an embodiment of a boss that projects downwardly from a bottom surface of the rotatable support element;

FIG. 13 is a top perspective view of another embodiment of a storage device of the present disclosure including two rotatable support element, an upper one of the two rotatable support elements having a larger diameter than a lower one of the two rotatable support elements;

FIG. 14 is a front perspective view of an embodiment of a storage device positioned within a corner cabinet and illustrating pots and lids suspended from hooks placed in a slot of a rotatable support element of the storage device, the storage device including an arrester of one embodiment of the present disclosure;

FIG. 15 is another front perspective view of the storage device of FIG. 14 illustrated separated from the corner cabinet for clarity;

FIG. 16 is an expanded perspective view of a portion of the storage device of FIG. 14 and showing a handle of an item of cookware within a notch of the arrester;

FIGS. 17A-17C are top plan views of other embodiments of arresters including a plurality of cutouts formed in radial outer edges of the arresters;

FIG. 18 is a perspective view of another embodiment of a storage device including an arrester of another embodiment of the present disclosure, the arrester positioned proximate to a hook;

FIG. 19 is a top plan view of the arrester of FIG. 18;

FIG. 20 is a top plan view of a storage device of another embodiment of the present disclosure comprising a support element interconnected to a door;

FIG. 21 is a side elevation view of the storage device of FIG. 20 and further illustrating another embodiment of an arrester arranged a predetermined distance below the support element;

FIG. 22A is a perspective view of a hook of one embodiment of the present disclosure;

FIG. 22B is a top plan view of the hook of FIG. 22A;

FIG. 22C is a bottom plan view of the hook of FIG. 22A;

FIG. 22D is a front elevation view of the hook of FIG. 22A;

FIG. 22E is a left side elevation view of the hook of FIG. 22A;

FIG. 22F is a right side elevation view of the hook of FIG. 22A;

FIG. 23A is a perspective view of a hook of another embodiment of the present invention that has a square base;

FIG. 23B is a top plan view of the hook of FIG. 23A;

FIG. 23C is a front elevation view of the hook of FIG. 23A;

FIG. 23D is a side elevation view of the hook of FIG. 23A;

FIG. 23E is a rear elevation view of the hook of FIG. 23A;

FIG. 23F is a bottom plan view of the hook of FIG. 23A;

FIG. 24A is a perspective view of a hook of yet another embodiment of the present invention that includes two hook ends;

FIG. 24B is a top plan view of the hook of FIG. 24A;

FIG. 24C is a front elevation view of the hook of FIG. 24A;

FIG. 24D is a side elevation view of the hook of FIG. 24A;

FIG. 24E is a rear elevation view of the hook of FIG. 24A; and

FIG. 24F is a bottom plan view of the hook of FIG. 24A.

To assist in the understanding of embodiments of the present disclosure, the following list of components and associated numbering found in the drawings is provided herein:

| Number | Component |
|---|---|
| 4 | Storage device |
| 6 | Notch |
| 8 | Support element |
| 9 | Top surface of support element |
| 10 | Frame assembly |
| 11 | Bottom surface of support element |
| 12 | Slot |
| 13 | Slot portion |
| 14 | Bridge |
| 16 | Cutout |
| 18 | Second support element |
| 19 | Flange |
| 20 | Upper indexer |
| 22 | Riser |
| 24 | Vertical support |
| 26 | Brace |
| 28 | Lower indexer |
| 30 | Upper slot portion |
| 32 | Upper slot width |
| 34 | Upper slot depth |
| 36 | Lower slot portion |
| 38 | Lower slot width |
| 40 | Lower slot depth |
| 42 | Ledges |
| 44 | Slot vertical portion |
| 46 | Boss |
| 50 | Arrester |
| 52 | Radial edge |
| 54 | Notch |
| 56 | Cookware |
| 57 | Handle |
| 58 | Cabinet |
| 60 | Hook |
| 61 | Hook lower end |
| 62 | Hook shank |
| 64 | Hook base |
| 66 | Hook base width |
| 68 | Hook base thickness |
| 104 | Storage device |
| 108 | Support element |
| 110 | Door |
| 112 | Slot |
| 113 | Slot portions |
| 114 | Bridge |
| 115 | Handle |
| 117 | Hinge |
| 130 | Upper slot portion; |
| 150 | Arrester |
| 160 | Hook |
| 161 | Hook lower end |
| 162 | Hook shank |
| 164 | Hook base |
| 260 | Hook |
| 261A | Hook lower end |
| 261B | Second lower end of hook |
| 262 | Hook shank |
| 264 | Hook base |

It should be understood that the drawings are not necessarily to scale. In certain instances, details which are not necessary for an understanding of the disclosure or which render other details difficult to perceive may have been omitted. It will also be understood that the disclosure is not necessarily limited to the particular embodiments illustrated herein.

### DETAILED DESCRIPTION

Various embodiments of the present disclosure are described herein and depicted in the drawings. To acquaint persons skilled in the pertinent arts most closely related to the present disclosure, a preferred embodiment that illustrates the best mode now contemplated for putting the disclosure into practice is described herein by, and with reference to, the annexed drawings that form a part of the specification. This exemplary embodiment is described in detail without attempting to describe all of the various forms and modifications in which the disclosure might be embodied. As such, the embodiments described herein are illustrative and, as will become apparent to those skilled in the arts, may be modified in numerous ways within the scope and spirit of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

The term “hook” as used herein refers to any element designed to hold any type of item in a hanging relationship. Hooks of the present disclosure are of various sizes and materials and are not limited to a “J” shape. Thus, hooks of the present disclosure can include one or more hanging surfaces. A hook can be double sided and/or can include multiple hanging surfaces in a vertical relationship. Additionally, or alternatively, hooks of the present disclosure can be adapted to hold various different items. For example, hooks of the present disclosure can be used to hold items of cookware (such as pots, pans, lids, cups, etc.), utensils (including cooking utensils, brooms, mops, dusters, dust pans, shovels, rakes, squeegees, gardening tools, and the like), clothing and accessories (for example, hats, ties, belts, purses, handbags, scarves, clothes hangers, and similar items), tools, and recreational equipment (such as rackets, backpacks, hiking gear, etc.).

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

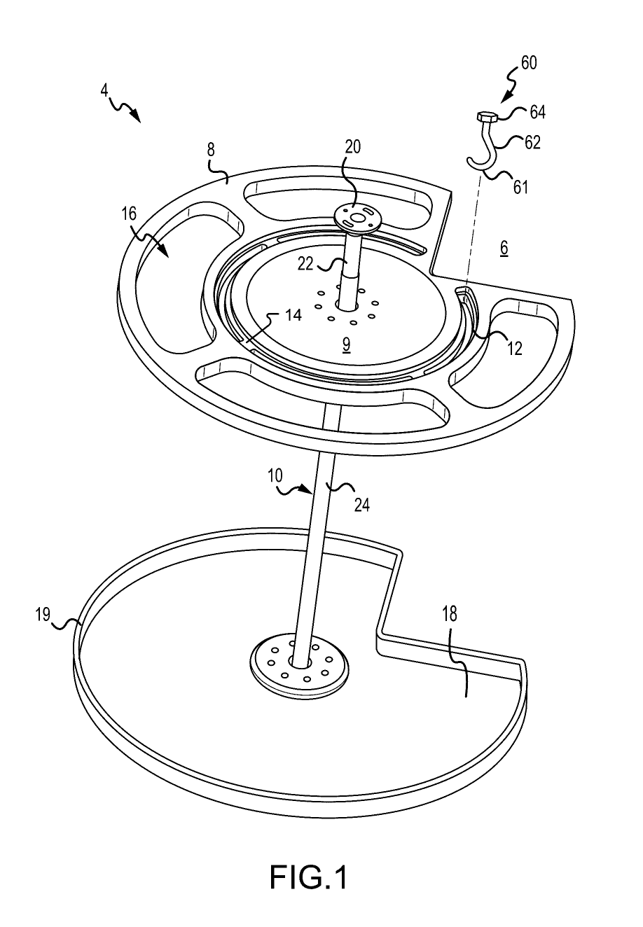

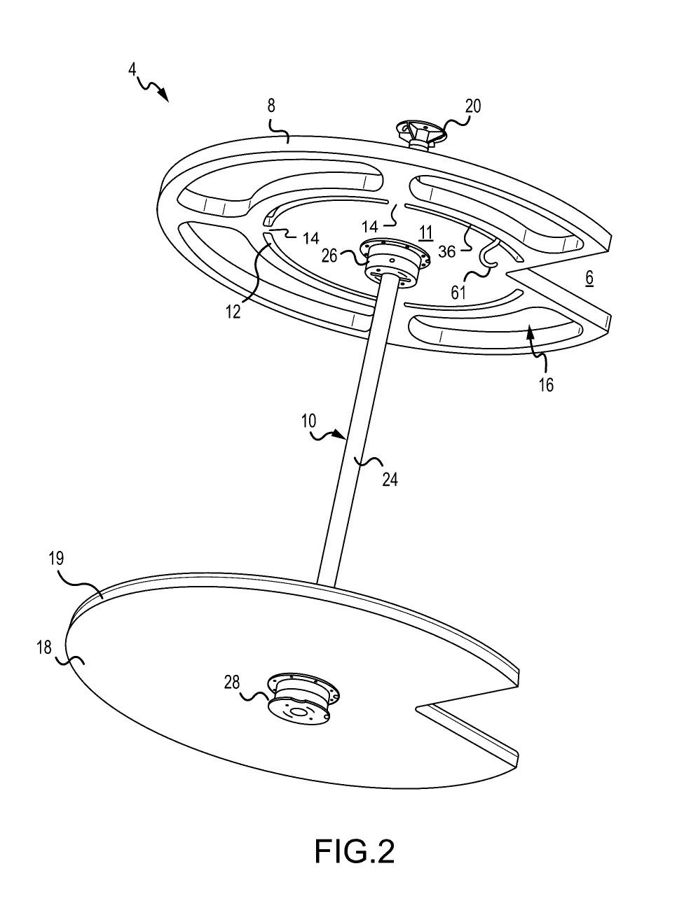

Referring now to FIGS. 1-2, a storage device 4 of one embodiment of the present disclosure is illustrated. The storage device 4 generally comprises at least one support element 8 rotatably interconnected to a frame assembly 10.

The support element 8 has a generally circular shape. In one embodiment, a notch 6 is formed in a portion of the support element. The notch 6 is generally triangular with a substantially right angle. The notch 6 is adapted to align with an interior surface of a door of a corner cabinet. The support element 8 may have a diameter selected to fit within a corner cabinet. In one embodiment, the support element 8 has a radius of between about 12 inches to about 16 inches. In a more preferred embodiment, the support element 8 radius is about 14 inches.

At least one slot 12 is formed through the support element 8. The slot extends from the top surface 9 of the support element 8 through the bottom surface 11 of the support element. The support element 8 can be made of any material. In one preferred embodiment, the support element 8 is made of a material selected from the group consisting of wood, plastic, metal, and combinations thereof. In one embodiment, the support element 8 comprises plywood, such as a 9-ply laminated wood product known to those of skill in the art.

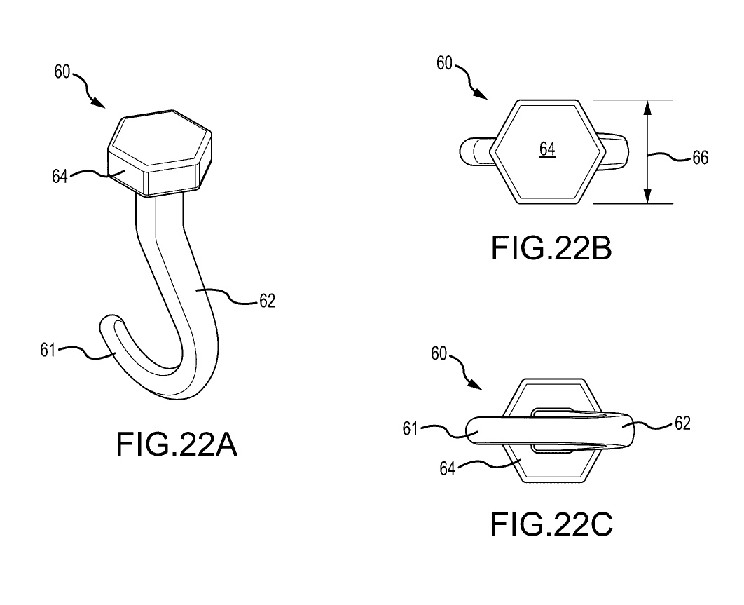

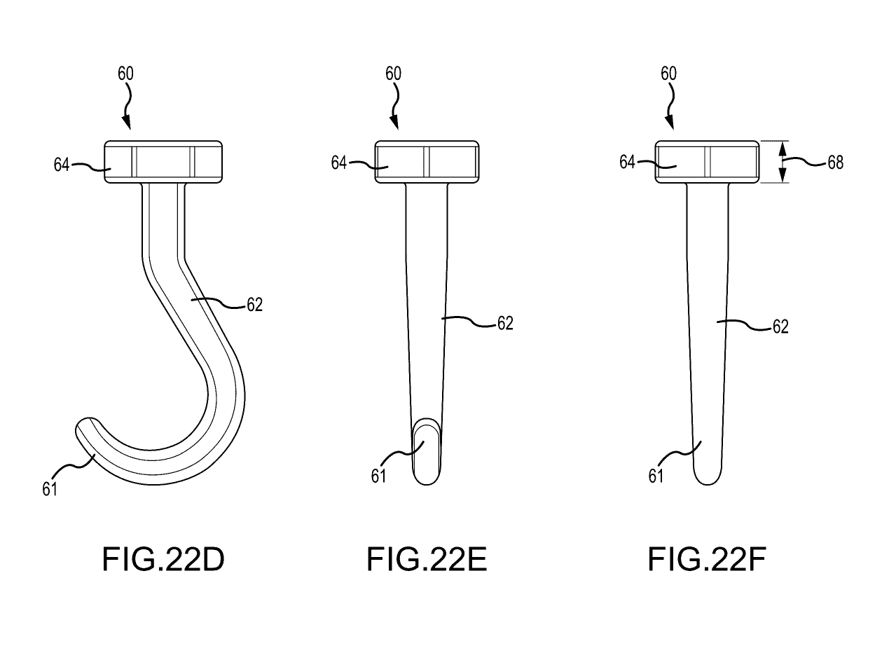

One or more hooks 60 may be releasably positioned through the slot 12. The hook 60 generally includes a base 64 adapted to be releasably retained in the slot 12. A lower end 61 of the hook 60 is adapted to hold any type of item in a hanging relationship with the storage device 4. The hook 60 can have a variety of shapes and lengths. One embodiment of a hook of the present disclosure is described in more detail in conjunction with FIG. 22.

Optionally, in one embodiment of the present disclosure, the support element 8 may include at least one cutout 16. The cutout 16 may have any shape or size. Each cutout 16 may be of a different size and shape. In one embodiment, the cutout 16 has a size sufficient to receive a user's fingers. Accordingly, the cutout 16 may be used to gasp a portion of the support 8 and impart a rotational force to the support element 8. Further, the cutout 16 can have a shape adapted to hold utensils or other items.

As one of skill in the art will appreciate, the storage device 4 may include any number of support elements 8. Thus, the storage device 4 may include an optional second support element 18. The second support element 18 is rotatably interconnected to the frame assembly 10. In one embodiment, the second support element 18 is substantially concentrically aligned with the support element 8. The second support element 18 may be the same as, or similar to, support element 8. Optionally, the second support element 18 may include a flange 19. The flange 19 projects upwardly proximate to an outer radial edge of support element 18. The flange 19 may prevent items stored on the substantially flat upper surface of support element 18 from falling off when the support element 18 when it is rotated. It will be appreciated that support element 8 may also include a flange that is the same as, or a similar to, flange 19. Alternatively, as illustrated in FIGS. 1-2, the second support element 18 does not include slots or cutouts. However, slots and cutouts of any size or shape may be formed in the support element 18.

The frame assembly 10 generally comprises an upper indexer 20, a riser 22, a vertical support 24, a brace 26, and a lower indexer 28. It will be appreciated that the frame assembly may comprise more, or fewer, elements. The upper indexer 20 and the lower indexer 28 are adapted to be interconnected to opposing surfaces that are substantially parallel. The vertical support 24 has a diameter selected to fit within an aperture of the lower indexer 28. The riser 22 slidingly interconnects to the vertical support 24. In one embodiment, at least a portion of the brace 26 rotates with respect to the riser 22 and the vertical support 24. In another embodiment, the vertical support 24 rotates axially with respect to the riser 22. In this manner, the brace 26 may be fixedly interconnected to the vertical support 24 and rotate axially with respect to the riser 22.

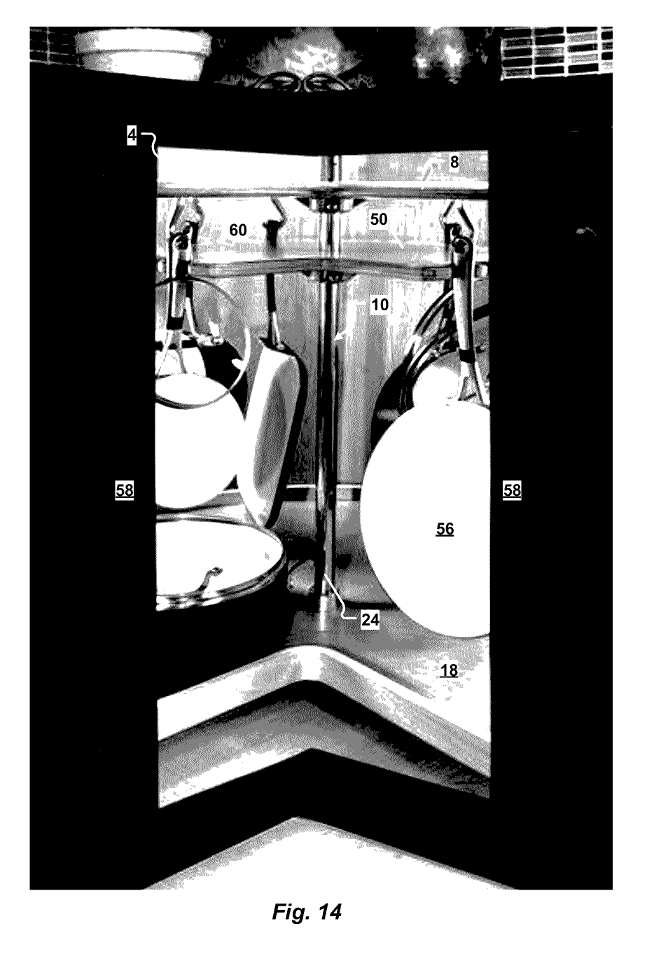

In one embodiment, the vertical support 24 and the riser 22 are generally tubular. Accordingly, the riser 22 may have an exterior diameter selected to fit within an axial bore of the vertical support 24. The position of the riser 22 with respect to the vertical support 24 may be adjusted by a user to alter the length of the frame assembly 10 as necessary to fit between any two opposing surfaces. In one embodiment, the riser 22 is retained in a position selected by the user by a friction fit. In another embodiment, the frame assembly 10 includes a lock to retain the riser 22 in a selected position. The lock may comprise a series of apertures formed in the vertical support 24 and a corresponding protrusion formed on an exterior surface of the riser 22. The protrusion may be biased to an extended position. In one embodiment, the opposing surfaces are a lower surface and an upper surface within an interior space of a corner cabinet. An example of a corner cabinet 58 is illustrated in FIG. 14. The following patents and patent publications are generally directed to components of shelves adapted to be positioned within a corner cabinet and are incorporated by reference to provide additional written description support for various aspects of the present disclosure: U.S. Pat. No. 3,868,156, U.S. Pat. No. 3,982,800, U.S. Pat. No. 4,146,280, U.S. Pat. No. 4,181,037, U.S. Pat. No. 4,440,459, U.S. Pat. No. 5,249,856, U.S. Pat. No. 6,017,108, U.S. Pat. No. 6,991,305, U.S. Pat. No. 8,459,474, U.S. Pat. No. 9,022,236, U.S. Pat. No. RE37,943, U.S. Patent Application Publication No. 2011/0127228, U.S. Patent Application Publication No. 2012/0205333, and European Patent Publication 1712153.

The brace 26 is adapted to interconnect the support element 8 to the vertical support 24. The brace 26 may be positioned at any location on the vertical support 24. Accordingly, the user may raise or lower the position of the brace 26 to adjust the position of the support 8, for example, within a corner cabinet.

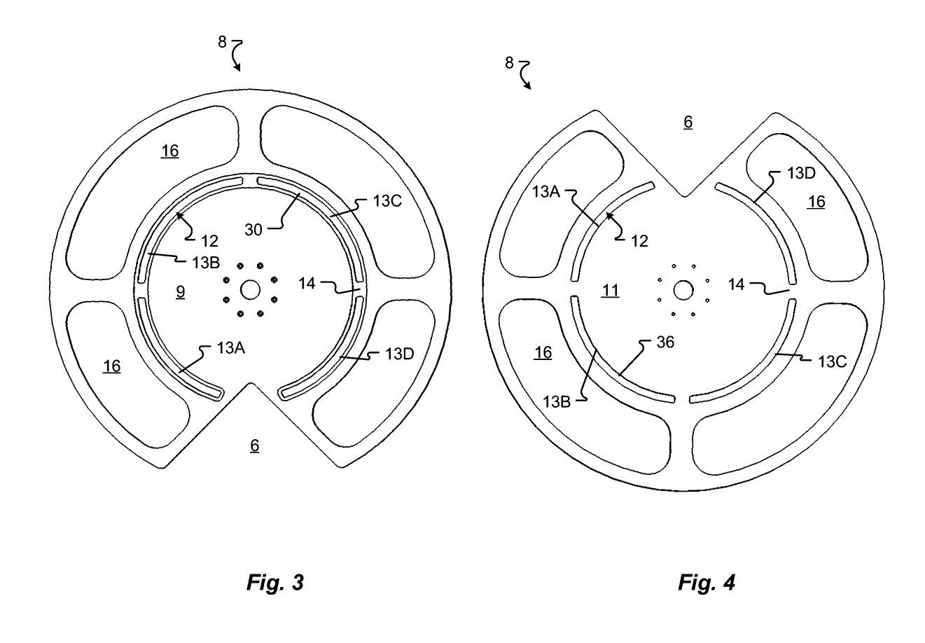

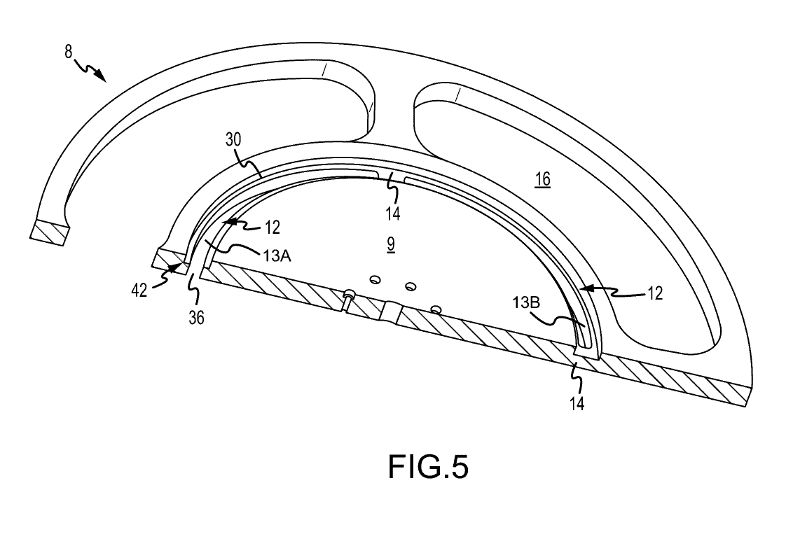

Referring now to FIGS. 3-5, in one embodiment of the present disclosure, the slot 12 has a generally arcuate shape that is substantially parallel to, or spaced a predetermined distance from, a circumference of the support element 8. In one embodiment of the present disclosure, the slot 12 has a radius of between about 5 inches to about 9 inches. In a more preferred embodiment, the slot radius is about 7 inches. As will be recognized, a longer slot 12 results in the ability to use a larger number of hooks 60. Accordingly, the slot 12 is preferably substantially continuous to maximize the usage of the existing storage volume. In one embodiment, one or more bridges 14 are formed between portions 13A, 13B, 13C, 13D of the slot 12. The bridges 14 provide support for portions of the support element 8 radially outward of the slot 12. In one embodiment, the bridges 14 are aligned substantially parallel to a radius of the support element 8.

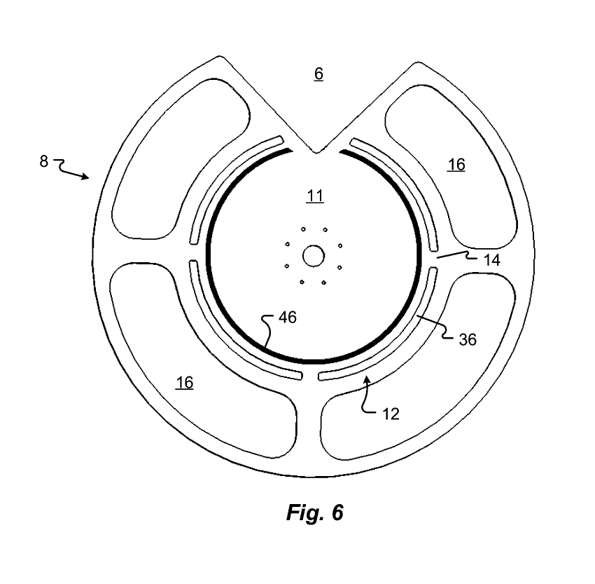

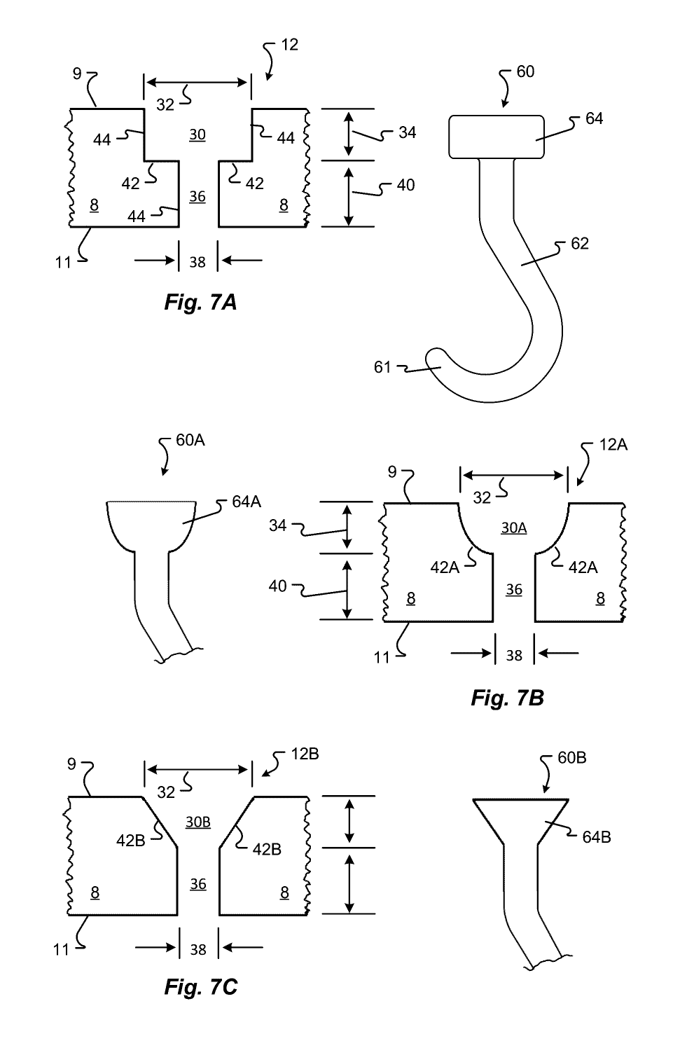

The slot 12 generally comprises an upper portion 30 that is wider than a lower portion 36. The upper portion 30 forms shoulders or ledges 42 above the lower portion 36. The ledges 42 are described in more detail in conjunction with FIG. 7.

It has been observed that when the support element 8 is rotated, items hanging from the hooks 60 occasionally pivot radially outwardly. When the rotational movement of the support element 8 stops, the items on the hooks 60 pivot or oscillate radially inwardly. Accordingly, and referring now to FIG. 6, in one embodiment of the present disclosure, a boss 46 may project downwardly from a bottom surface 11 of the support element 8. In this manner, the boss 46 may prevent the hooks 60, and items suspended from the hooks 60, from oscillating or pivoting radially inwardly or in other unintended directions.

The boss 46 may have a generally circular shape. Additionally, the boss 46 may be substantially parallel to a radially interior edge of the lower slot portion 36. The size and the position of the boss 46 are selected to provide support to an item hanging from a hook 60 positioned in the slot 12. Although the boss 46 is illustrated in FIG. 6 with a radius less than the radius of the slot 12, the boss 46 may have a radius substantially equal to the radius of the slot 12. Accordingly, in one embodiment, the exterior radius of the boss 46 is substantially equal to the interior radius of the radially interior edge of the lower slot portion 36.

In one embodiment, the boss 46 extends downward from the bottom surface 11 of the support element 8 at least as far as the hook lower end 61 projects downwardly from the slot 12. In another embodiment, at least a portion of the boss 46 contacts a portion of a handle of an item handing from a hook 60. In one embodiment, the boss 46 contacts at least one of the hook 60 and an item hanging from the hook 60. In another embodiment, the boss 46 biases at least the hook 60 radially outwardly (away from the frame assembly 10). The boss 46 may be integrally formed with the support element 8. Optionally, the boss 46 may be formed of a different material, such as an elastomeric material. In one embodiment, the boss 46 is interconnected to the bottom surface 11 of the support element 8

Referring now to FIG. 7A, a cross-sectional view of a slot 12 of one embodiment of the present disclosure is illustrated. The lower slot portion 36 has a width 38 that is sufficient to allow a shank 62 and lower end 61 of a hook 60 to pass through the slot 12. In one embodiment, the lower slot width 38 is between approximately 0.25 inch and 0.75 inch. In a more preferred embodiment, the lower slot width 38 is approximately 0.5 inch. The lower slot width 38 is less than a width 32 of the upper slot portion 30. In one embodiment, the upper slot width 32 is between about 0.75 inch and 1.25 inches. The upper slot width 32 is approximately 1 inch in a more preferred embodiment.

The upper slot portion 30 has a depth 34 substantially equal to, or slightly greater than, a thickness 68 of the hook base 64. In one embodiment of the present disclosure, the upper slot depth 34 is between about 0.25 inch and 0.5 inch. The upper slot depth 34 is about 0.375 inch in a more preferred embodiment.

In one embodiment, illustrated in FIG. 7A, the ledges 42 of the slot 12 have substantially straight surfaces substantially parallel to an upper surface 9 of the support element 8. Generally vertical portions 44 of the slot 12 are substantially perpendicular to the upper surface 9. Accordingly, the upper and lower slot portions 30, 36 each have a generally rectangular cross-sectional profile.

The upper slot portion 30 may be continuous along a length of the slot 12. In operation, the hook base 64 of a hook 60 may fit within the upper portion 30 and be supported by the ledges 42. A shank 62 of a hook 60 has a length that is greater than the depth 40 of the lower slot portion 36. Thus, a lower end portion 61 of the hook 60 may extend below the bottom surface 11 of the support element 8.

The lower slot portion 36 may be interrupted along the length of the slot 12 by one or more bridges 14 as illustrated in FIGS. 3-4. Accordingly, the lower slot portion 36 may be discontinuous. Additionally, or alternatively, the upper slot portion 30 may be discontinuous and formed at regular intervals along the length of the slot 12, forming a series of notches. The notches may have a size and shape adapted to receive a hook base 64 positioned inside the notch.

As will be appreciated, the size and shape of the upper and lower slot portions 30, 36 may be altered. Further, the relative size of the upper portion 30 compared to the lower portion 36 may be changed. Optionally, in one embodiment, the slot 12 has a substantially uniform width without ledges. In this embodiment, the hook base 64 sits on top of the top surface 9 of the support element 8.

The ledges 42 and the slot 12 can have any shape adapted to support or engage the hook base 64 while allowing the hook lower end 61 to pass through the lower slot portion 36. Thus, the cross-sectional profile of the slot 12 may be a square, a rectangle, a T-shape, an inverted cone, or any other applicable shape that allows the hook lower end 61 to pass completely through the slot 12 while simultaneously providing a surface upon which the hook base 64 may rest.

Referring now to FIG. 7B, in one embodiment, the ledges 42A have arcuate profiles resembling an upward opening U. Said another way, the upper slot portion 30A has a generally elliptical or arcuate cross-sectional profile and the lower slot portion 36 has a generally rectangular cross-sectional profile. The ledges 42A formed by the upper slot portion 30A intersect the upper surface 9 of the support element 8. A hook 60A of another embodiment has a base 64A with a shape substantially corresponding to the cross-section profile of the upper slot portion 30A.

In another embodiment, illustrated in FIG. 7C, the ledges 42B have slopping walls forming a cross-sectional shape resembling an inverted cone. In one embodiment, the ledges 42B are substantially straight but transverse to the upper surface 9 of the support element 8. In this manner, the ledges 42B intersect the upper surface 9 of the support element 8. In this embodiment, the upper slot portion 30B has a generally triangular cross-sectional profile and the lower slot portion 36 has a generally rectangular cross-sectional profile. A hook 60B with a base 64B of another embodiment has a shape substantially corresponding to the cross-section profile of the upper slot portion 30B.

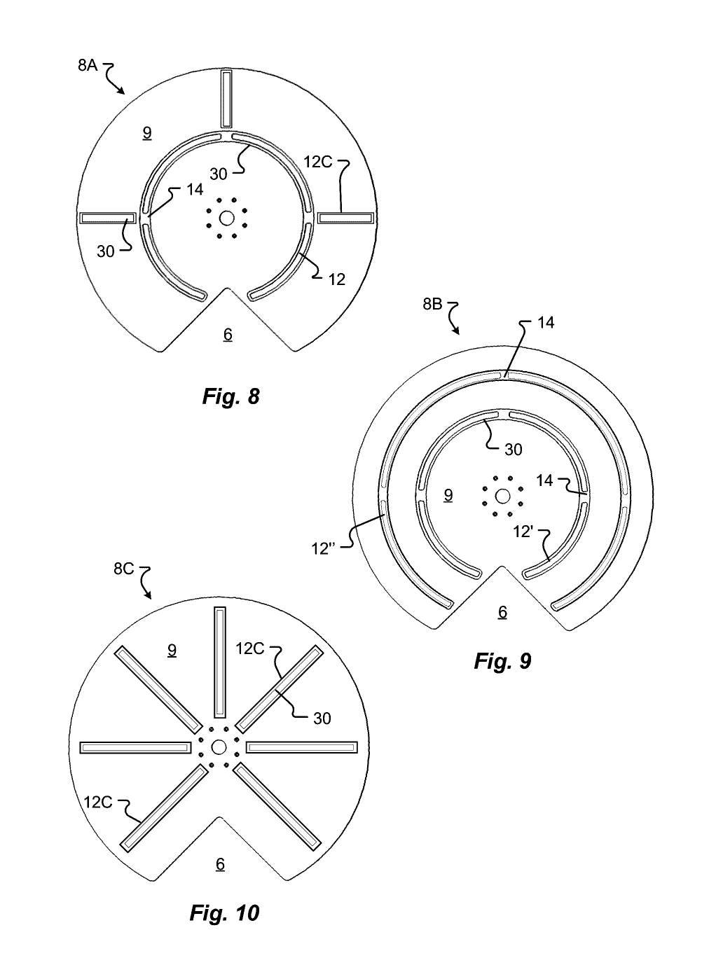

Referring now to FIGS. 8-10, alternate embodiments of support elements 8A, 8B, 8C of the present disclosure are illustrated. In one embodiment of the present disclosure, illustrated in FIG. 8, the support element 8A includes a slot 12. The slot 12 may be the same as, or similar to, the slot of support element 8. The support element 8A does not include cutouts. Accordingly, support element 8A has a greater surface area available for supporting items than support element 8 of a similar diameter. Further, if the upper slot portion 30 has a width 32 greater than the width 66 of the hook base 64, the upper surface 9 of support element 8A will provide a large surface without protrusions for storing items. Optionally, one or more slots 12C that have a generally radial orientation may be formed in support element 8A. Said another way, the radial slots 12C are substantially parallel to a radius of the support element 8A. The slots 12C may have the same, or similar, dimensions and cross-sectional shapes as the slots 12 with a generally axial orientation of support element 8. The slots 12C may have any of the cross-sectional profiles described in conjunction with FIG. 7.

Referring now to FIG. 9, another embodiment of a support element 8B is illustrated which includes two slots 12′, 12″. In one embodiment, the slots 12′, 12″ are generally concentric. The slots 12′, 12″ may be the same as, or similar to, other embodiments of slots described herein, including those described with respect to FIG. 7. As will be appreciated, the support element 8 may have any number of slots 12. Further, the slots may have different shapes and/or may be non-concentric. Optionally, the support element may include one or more cutouts similar to the cutout 16 of support element 8. In one embodiment, an inner slot 12′ of the support element 8B has a length that is substantially equally spaced from a length of the outer slot 12″.

Referring now to FIG. 10, still another embodiment of a support element 8C is illustrated. The support element 8C includes slots 12C that have a generally radial orientation. As will be appreciated, a support element may include a combination of both radial slots 12C and axially oriented slots 12 as illustrated in FIG. 8.

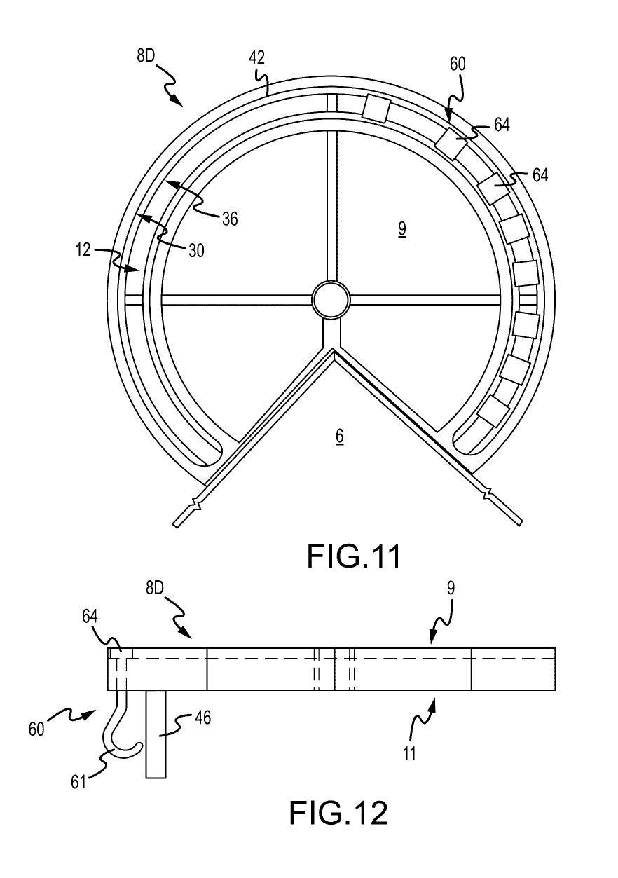

Referring now to FIGS. 11-12, another embodiment of a support element 8D of the present disclosure is illustrated. The support element 8D includes a slot 12 that is the same as, or similar to, the slot 12 of support element 8. However, the slot is positioned closer to the outer axial edge of the support element 8D. Hooks 60 with a substantially square base 64 are illustrated in the slot. In one embodiment, when the hooks 60 are in the slot 12, the hook bases 64 do not project above a plane formed by the upper surface 9 of the support element 8D.

As previously described, a boss 46 may optionally project downwardly from a bottom surface 11 of the support element 8D. The boss 46 may project downwardly further than from the bottom surface 11 than the lower end 61 of the hook 60. Further, the boss 46 may be positioned to contact at least a portion of the hook 60 or a handle of an item hanging therefrom. In this manner, the boss 46 may prevent one or more of the hook 60 and the item handle from moving radially inwardly.

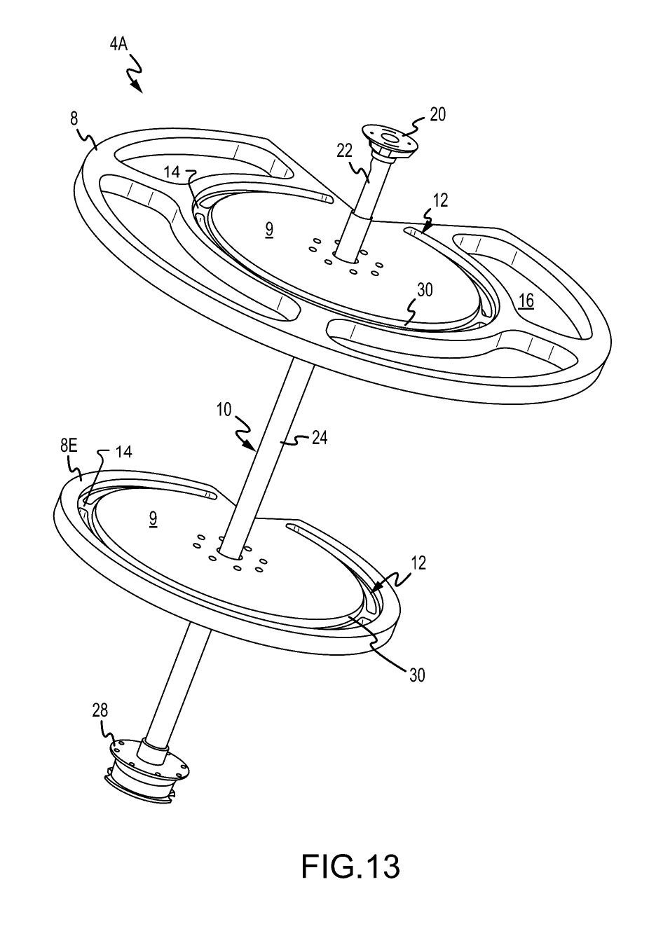

Referring now to FIG. 13, a storage device 4A of another embodiment of the present disclosure is illustrated. The storage device 4A generally comprises two support elements 8, 8E rotatably interconnected to a frame assembly 10. A storage device may comprise any number of support elements 8. Optionally, support element 8E is devoid of cutouts 16. Support elements 8, 8E each include slots 12 of substantially the same size and orientation. However, a storage device 4 may include support elements 8 of any size or shape and any combination of slots 12, 12A, 12B, 12C of any number, size, and orientation. In one embodiment of the present disclosure, the support elements 8, 8E are interconnected to the frame assembly 10 in a manner to rotate in unison. In another embodiment, each of the support elements 8, 8E is independently rotatable around the frame assembly 10.

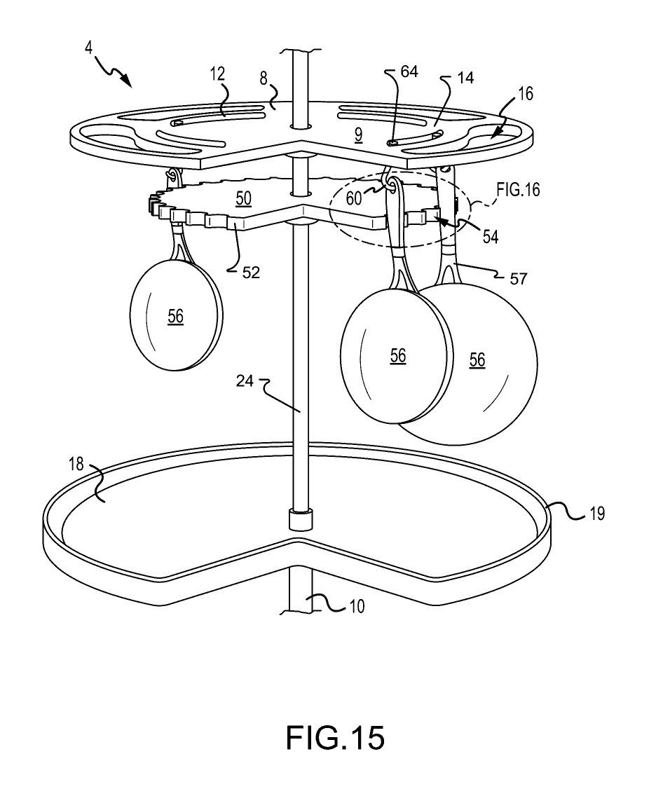

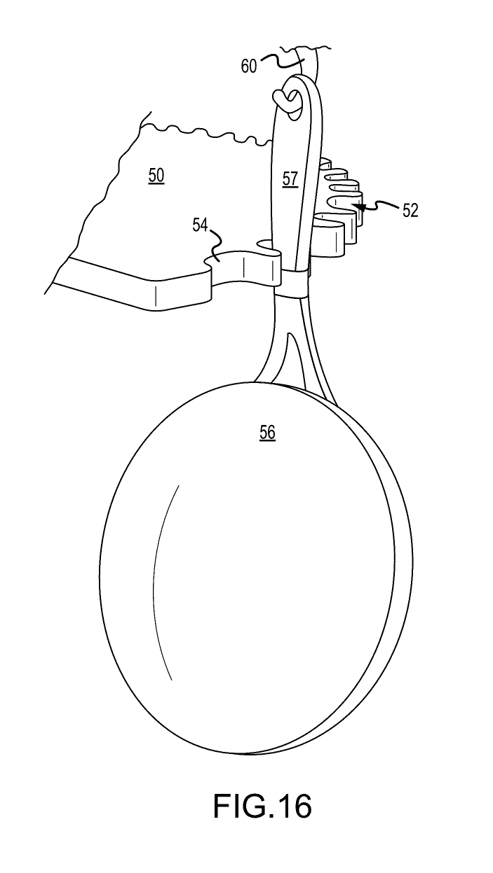

Referring now to FIGS. 14-19, the storage devices 4 of the present disclosure may also include an arrester 50 interconnected to the frame assembly 10. The position of the arrester 50 on the vertical support 24 of the frame assembly 10 is selected to be proximate to a hook end 61. A user may change the axial position of the arrester 50 on the vertical support 24. In this manner, the arrester 50 can provide support to at least a portion of a hook 60 or an item 56, such as a pot or a pan, hanging from the hook 60. In one embodiment, the arrester 50 is interconnected to the frame assembly 10 such that the arrester 50 rotates axially when the support element 8 is rotated. Accordingly, when the support element 8 is rotated around an axis of the frame assembly 10, items hanging from hooks 60 (such as cookware 56) are supported by the arrester 50 and do not move inadvertently. In this manner, the items 56 do not strike other items 56 or a cabinet 58 in which the storage device 4 is positioned.

The arrester 50 has a shape similar to the shape of the support element 8. Optionally, in one embodiment, the arrester may have a shape that is substantially circular without a notch. The radius of the arrester 50 is about equal to the radius of the slot 12. Thus, in one embodiment, the arrester 50 has a radius of between about 5 inches to about 9 inches. In a more preferred embodiment, the arrester radius is about 7 inches. In one embodiment, the arrester 50 may have a slot 12. Accordingly, the arrester 50 may be similar to the lower support element 8E illustrated in FIG. 13.

Optionally, as illustrated in FIGS. 14-16, the outer radial edge 52 of the arrester 50 may have a plurality of notches or grooves 54. The grooves 54 are adapted to receive a portion of a hook 60 and/or a handle 57 of an item 56 hanging therefrom.

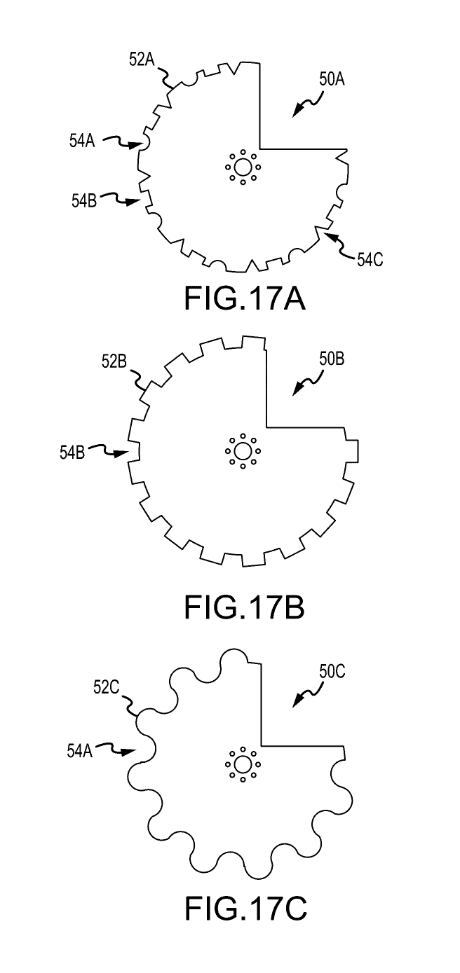

Referring now to FIGS. 17A-17C, the notches 54 may have a shape of one or more of a semi-circle 54A, a square 54B, a triangle 54C, and any combination thereof. Optionally, the arrester 50A may include a variety of notches 54 with different shapes. Alternatively, the shape of the notches 54 for the arrester 50 may be substantially uniform, as illustrated by arrester 50B with only generally square notches 54B. Similarly, arrester 50C comprises only generally semi-circular notches 54A. The grooves 54 may prevent or limit both axial and radial movement of the hooks 60 and item handles 57 when the support element 8 is rotated and when the rotation of the support element stops. In one embodiment of the present disclosure, the arrester 50 is interconnected to the frame assembly 10 such that when the support element 8 rotates, the arrester 50 rotates at a similar rate.

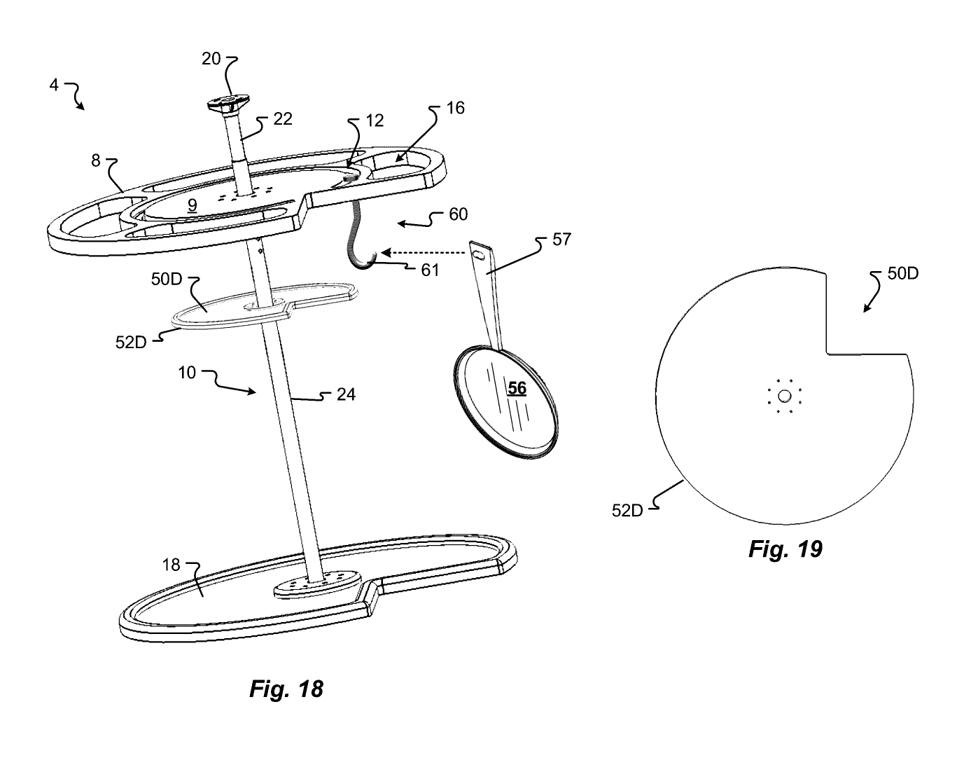

Referring now to FIGS. 18-19, in one embodiment of the present disclosure, the outer radial edge 52D of the arrester 50D may be is generally circular and devoid of notches 54.

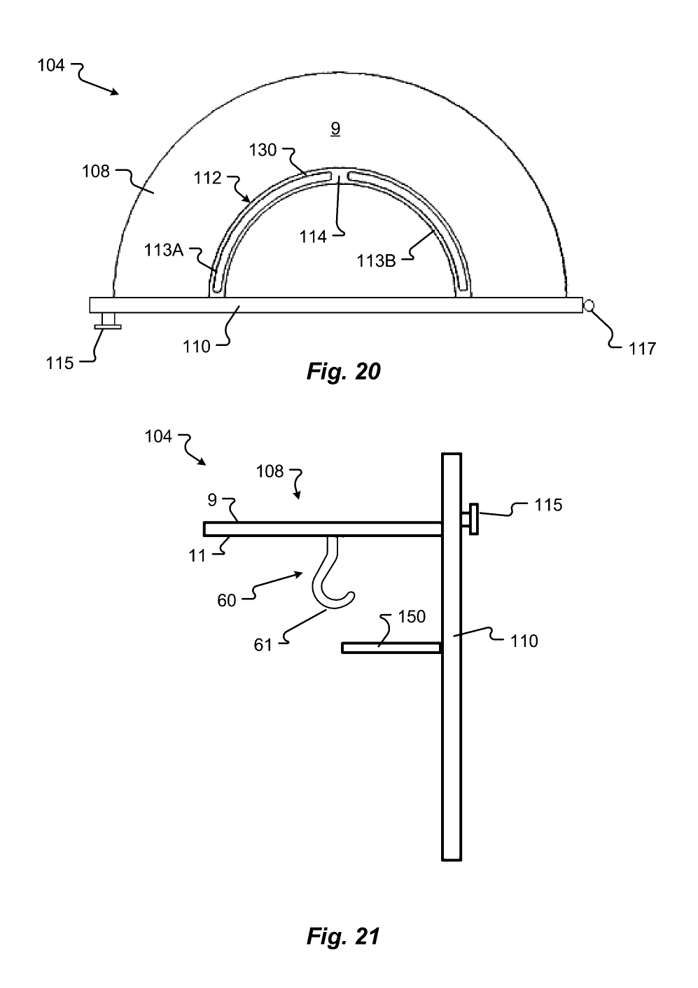

Referring now to FIGS. 20-21, storage device 104 of another embodiment of the present disclosure is illustrated. The storage device 104 comprises a support element 108 interconnected to a vertical support 110.

The support element 108 includes a slot 112 that is the same as, or similar to, slots 12 described herein. The slot 112 extends from the top surface 9 of the support element 108 through the bottom surface 11 of the support element108. The slot 112 may be formed at any position of the support element 108. In one embodiment, the slot 112 is substantially parallel to an outer radial edge of the support element 108. The slot 112 may be positioned closer to, or further from, the radial edge. Further, as describe above in conjunction with FIG. 9, two or more slots 112 may be formed in the support element 108. Additionally, or alternatively, at least one axial slot, the same as or similar to axial slots 12C illustrated in FIG. 10, may be formed in the support element. At least one hook 60 may be positioned in the slot 112. In one embodiment, the slot 112 includes a first portion 113A separated from a second portion 113B by a bridge 114.

The slot 112 may have any cross-sectional profile. In one embodiment, the slot 112 has a cross-sectional profile the same as, or similar to, one of the slots 12, 12A, 12B described in conjunction with FIGS. 7A, 7B, and 7C respectively. Accordingly, the slot 112 generally includes an upper portion 130 that has a width that is greater than a lower portion.

A diameter of the support element 108 is about equal to, or slightly less than, a width of the vertical support 110. In one embodiment of the present disclosure, the vertical support 110 comprises a door. Accordingly, the support element 108 may be positioned entirely within an interior space sealed by the door 110.

An arrester 150 may optionally be interconnected to the door 110 below the support element 108. Similar to arrester 50, the arrester 150 is adapted to prevent unintended movement of the hooks 60 and items hanging therefrom. The arrester may have a generally uninterrupted outer radial edge similar to arrester 50. Alternatively, the arrester 150 may have a plurality of notches similar to notches 54.

A handle 115 may be attached to, or formed in, the door 110. The handle 115 may be selected from the group consisting of a lever, a knob, a hook, a handle, an indent, and any other suitable device that can be grabbed or grasped by a user to change a position of the door 110. The door 110 may be interconnected to a frame of a cabinet by any suitable means. In one embodiment, the door 110 is interconnected to a cabinet frame by a hinge 117.

Referring now to FIG. 22, a hook 60 according to one embodiment of the present disclosure is illustrated. The hook 60 includes a shank 62 that extends from a head or base 64 of the hook.

The hook base 64 may be of any size or shape. The hook base 64 has a width 66 that is substantially equal to the upper slot width 32. Accordingly, in one embodiment of the present disclosure, the width 66 of the hook base 64 generally conforms to the upper slot width 32 to prevent unintended or inadvertent movement of the hook 60 within the slot 12, 112. In one embodiment, the base width 66 is between about 0.75 inch and 1.25 inches. The base width 66 is slightly less than approximately 1 inch in a more preferred embodiment. Additionally, or alternatively, the base width 66 may be sufficiently less than the upper slot width 32 to allow the hook base 64 to rotate at least slightly within the slot upper portion 30, 130.

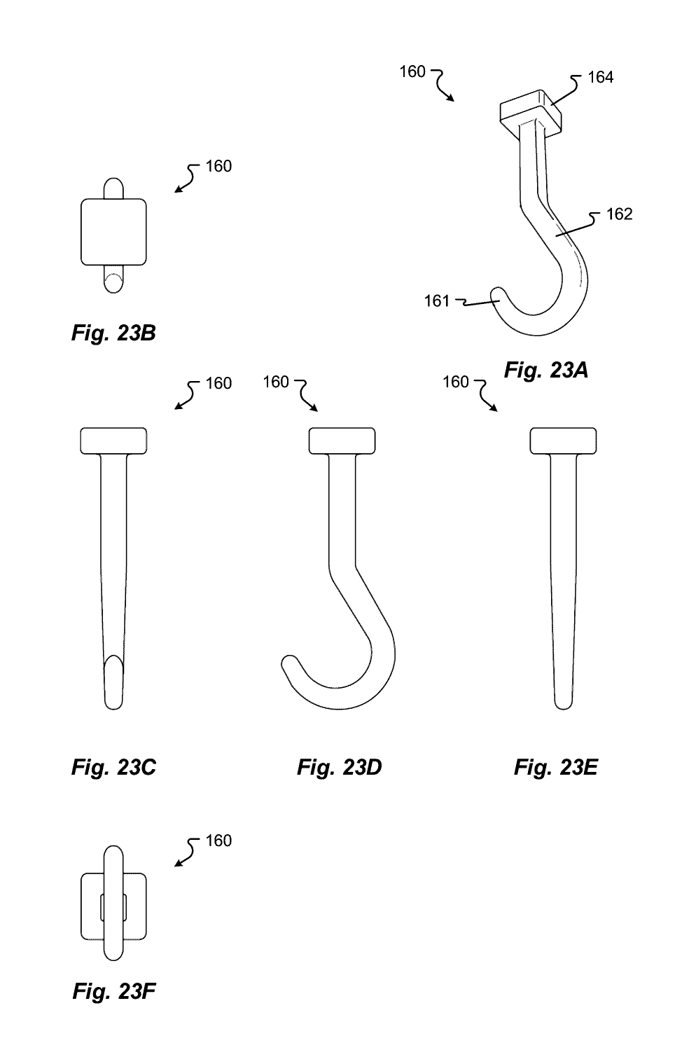

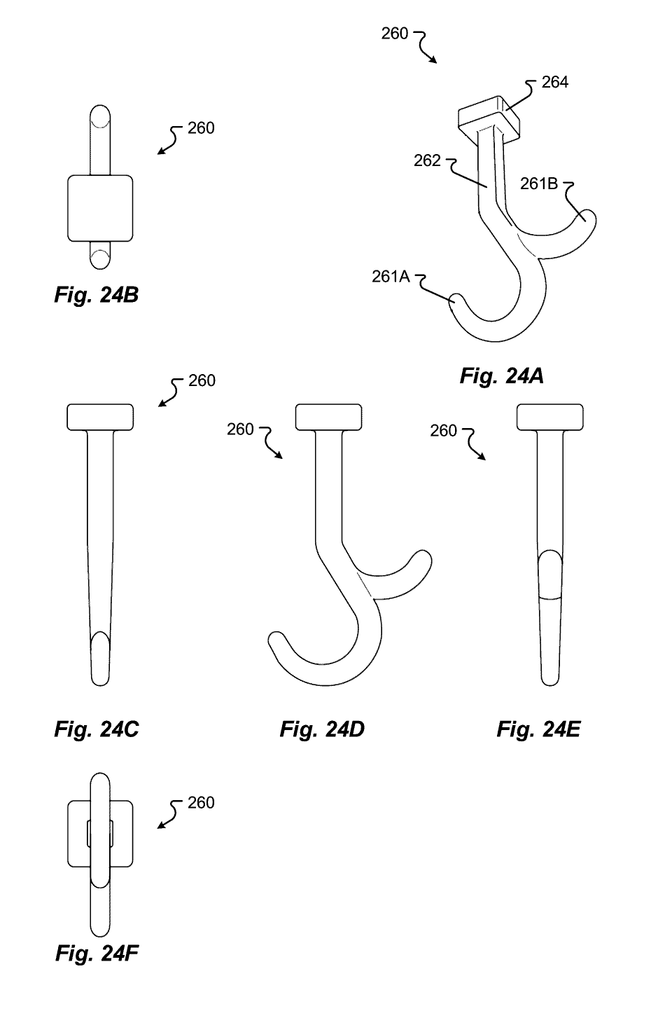

In one embodiment, illustrated in FIG. 22, the hook base 64 has a generally hexagonal shape. The hexagonal shape enables the lower end 61 of the hook to be positioned in multiple alignments by rotating the hook base 64 with respect to the slot 12, 112. However, other shapes of the hook base 64 are contemplated. For example, in another embodiment, illustrated in FIG. 23, the hook base 164 is generally square. In still another embodiment, the hook base 64 is round, elliptical, triangular, rectangular, octagonal, and/or combinations thereof or of any other suitable shape. In yet another embodiment, illustrated in FIG. 24, the hook 260 may include a first lower end 261A and a second lower end 261B.

In one embodiment, the hook shank 62 is fixedly attached to the hook base 64. Additionally, or alternatively, the shank can be rotatably interconnected relative to the hook base 64 such that the shank 62 can rotate axially.

Optionally, the hook 60 may be configured as a single unit, wherein the hook base 64, the shank 62, and the lower end 61 are all manufactured from the same piece of material. The hook 60 can be made of any suitable material known to those of skill in the art such as wood, plastic, metal, and/or combinations thereof.

Additionally, or alternatively, the hook 60 may be configured from a separate shank 62 and lower end 61 that are mechanically attached to the hook base 64. In one embodiment, an upper portion of the shank 62 is threaded. The threaded upper portion engages a threaded bore in the lower surface of the hook base 64. In another embodiment, the upper portion of the shank 62 is inserted in a bore through the hook base 64 and attached to the hook base by a fastener. The fastener may be selected from the group consisting of a pin, a screw, a nail, a weld, a monolith, and any other suitable fastening means. The shank 62 may also be connected to the lower surface of the hook base 64 by a weld, a pin, an adhesive, or by any other suitable means known to those of skill in the art. In one embodiment, a hook 60 includes a shank portion connected to a lower surface of a hook base 64. The shank portion includes a threaded bore at a lower end opposite the hook base. A lower end of the hook 60 has a threaded extension adapted to threadably engage the threaded bore to interconnect the lower end to the shank. Examples of other hooks that may be used with embodiments of the present disclosure are described in the Applicant's co-pending application, U.S. patent application Ser. No. 14/679,433 and Applicant's U.S. Pat. No. 9,022,237 which are each incorporated herein by reference in their entirety.

In all embodiments described herein, a user may add, remove, or rearrange hooks 60, 160, 260 within the slot without the disassembly of the storage device 4 or removal of the storage device 4, 104 from a mounting surface to which it is attached. The hooks 60, 160, 260 may also be repositioned along substantially the entire length the slot 12, 112. Further, hooks 60, 160, 260 may rotate axially about the shank 62, 162, 262 to change the orientation of the lower end 61, 161, 261 extending below the support element 8, 108. These features allow the user to customize the position of the hooks 60, 160, 260 to thereby efficiently position the articles 56 hanging from the hooks 60, 160, 260 within the storage space. The hooks 60, 160, 260 can also be easily removed for cleaning or any other reason.

Additionally, or alternatively, one or more protrusions, such as bumps, ridges, spheres, pins, pyramids, and the like, can be formed on a lower surface of the hook base 64, 164, 264. Multiple recesses having a corresponding shape are formed on the ledges 42 of the slots 12, 112. In operation, the protrusions of the hooks 60, 160, 260 align with the recesses and reduce or prevent inadvertent or unintended movement of the hook 60, 160, 260 within the slot 12, 112.

Additionally, or alternatively, the hook base 64, 164, 264 can include a magnet or be made of a magnetized material. A strip of magnetic material, or individual pieces of magnetic material, can be positioned on the ledges 42 or the sides of the slot 12, 112 above the ledges 42 to align with the magnet of the hook base 64, 164, 264. In operation, the attraction between the magnet and the magnetic material in the slot 12, 112 will prevent or reduce inadvertent or unintended movement of a hook 60, 160, 260 within the slot 12, 112. Further, a hook and loop material may be applied to bottom surface of the hook base 64, 164, 264 and the ledges 42 to retain the hooks 60, 160, 260 in a predetermined position.

The hook base 64, 164, 264 may be manufactured from wood, plastic, metal or combinations thereof. In a preferred embodiment, the hook base 64, 164, 264 may be manufactured from metal.

The hook base 64, 164, 264 is sized to fit at least partially into the slot 12, 112 and rest the ledges 42. In one embodiment, the hook base 64, 164, 264 has a width 66 of between approximately 0.445 inch and approximately 1.445 inches. In another embodiment, the width 66 of the hook base 64, 164, 264 is between approximately 0.645 inch and approximately 1.245 inch. In a more preferred embodiment, the width 66 of the hook base 64, 164, 264 is approximately 0.945 inch. In some embodiments the width 66 of the hook base 64, 164, 264 is greater than the width 32 of the slot upper portion 30. In this manner, the hook base 64, 164, 264 rests on the top surface 9 of the support element 8, 108.

In one embodiment of the present disclosure, the hook base 64, 164, 264 has a thickness 68 that is less than, or about equal to, the upper slot depth 34 of slots 12, 112. Thus, the hook base 64, 164, 264 does not project above a plane formed by the upper surface 9 of the support element 8, 108. In this manner, the upper surface 9 of the support element 8, 108 may be substantially free of projections and available for use to store other items. In one embodiment, the hook base thickness 68 is between about 0.25 inch and about 0.5 inch. The thickness 68 of the hook base 64, 164, 264 is about 0.380 inch in a more preferred embodiment. Additionally, or alternatively, the corners and the edges of the hook base 64, 164, 264 can be rounded. In one embodiment, each of the horizontal edges of the hook base 64, 164, 264 are rounded and have a radius of approximately 0.05 inch. In another embodiment, each of the vertical edges of the hook base 64, 164, 264 are rounded and have a radius of approximately 0.1 inch.

The hooks 60, 160, 260 described herein may be used with slots 12, 112 of all embodiments of this disclosure. The hook shank 62, 162, 262 has a sufficient length so that the lower end 61, 161, 261 extends below the bottom surface 11 of the support elements 8, 108. In one embodiment, the length of the hooks 60, 160, 260 is between about 2 inches and about 8 inches. In a more preferred embodiment, the length is between about 2.75 inches and about 3.25 inches. In a still more preferred embodiment, the length is about 3 inches. In another preferred embodiment, the length is between about 3.5 inches and 6 inches. In a still more preferred embodiment, the length is approximately 4.06 inches.

The hooks 60, 160, 260 include a lower end 61, 161, 261 adapted to releasably hold any desired item in a hanging relationship. As used herein, the term lower end refers to a lower portion of the hook 60, 160, 260 adapted to releasably retain an item of any type. The lower end 61, 161, 261 may be curved and have a J-shape. Additionally, or alternatively, the lower end 61, 161. 261 may comprise at least two straight sections connected at an angle. For example, the lower end can be substantially L-shaped or V-shaped to facilitate hanging various articles from the hook 60, 160, 260. In some embodiments, the lower end 61, 161, 261 may include a cord, cable, flexible material, a biased clip (such as a clothes pin or the like), a flexible loop, a noose, a spring-loaded clasp, or other suitable interface means.

Although various dimensions are provided to illustrate exemplary embodiments of hooks, storage devices, and the components thereof, and it is expressly contemplated that dimensions may be modified in storage devices and hooks of the present disclosure and still comport with the scope and spirit of the present disclosure.

The disclosure has been described with reference to various specific embodiments and techniques. However, it should be understood that many variations and modifications may be made while remaining within the spirit and scope of the disclosure.

It is appreciated that certain features of the disclosure, which are, for clarity, described in the context of separate embodiments, may also be provided in combination in a single embodiment. Conversely, various features of the disclosure that are, for brevity, described in the context of a single embodiment, may also be provided separately or in any sub-combination.

What is claimed is:

1. A rotatable storage device adapted to be positioned within an enclosed space, the storage device comprising:
a frame assembly oriented substantially vertically within the enclosed space;
a support element rotatably interconnected to the frame assembly, the support element comprising:
a top surface opposite a bottom surface; and
a slot formed through the support element and extending from the top surface through the bottom surface, the slot comprising a lower portion positioned below an upper portion, the lower portion of the slot having a width that is less than a width of the upper portion of the slot, wherein the slot is adapted to receive at least one hook by inserting the at least one hook through the slot from a top side of the support element.

2. The storage device of claim 1, wherein the slot further comprises two ledges formed by a transition from the wider upper portion of the slot to the narrower lower portion of the slot.

3. The storage device of claim 1, wherein the width of the lower portion of the slot is about 0.25 inch to about 0.75 inch, and wherein the width of the upper portion of the slot is about 0.75 inch to about 1.25 inches.

4. The storage device of claim 1, wherein the at least one hook includes a base and a shank extending from the base, the shank adapted to extend through the slot, the base having a width that is greater than the width of the lower portion of the slot, the width of the base being less than the width of the upper portion of the slot, and the base having a thickness that is at least equal to, but not greater than, a depth of the upper portion of the slot.

5. The storage device of claim 4, wherein a material of the at least one hook is selected from at least one of a wood, a plastic, and a metal, and wherein the at least one hook is one of:
configured as a single unit; and
configured of at least two pieces with the base interconnected to the shank.

6. The storage device of claim 1, wherein a radius of the slot is from about 5 inches to about 9 inches.

7. The storage device of claim 1, wherein the support element is substantially round and has a radius of from about 12 inches to about 16 inches, and wherein the slot is substantially parallel to an outer axial edge of the support element.

8. The storage device of claim 7, wherein the slot comprises two substantially concentric slots.

9. The storage device of claim 7, wherein the support element further comprises one or more of:
a notch;
at least one cutout formed through the support element;
a second slot that is oriented radially substantially parallel to a radius of the support element; and
a boss extending downwardly from the bottom surface of the support element.

10. The storage device of claim 7, wherein the support element is made of wood.

11. The storage device of claim 1, further comprising an arrester interconnected to the frame assembly, the arrester positioned below the support element.

12. The storage device of claim 11, wherein an outer axial edge of the arrester has at least one notch, and wherein the arrester has a radius of between about 5 inches and about 9 inches.

13. The storage device of claim 11, wherein the frame assembly comprises one or more of:
an upper indexer adapted to be interconnected to an upper structure;
a lower indexer adapted to be interconnected to a lower structure;
a vertical support interconnected to the lower indexer;
a riser interconnected to the upper indexer and the vertical support; and
a brace rotatably interconnected to the vertical support, the brace adapted to receive the support element.

14. The storage device of claim 1, wherein the support element comprises two support elements.

15. The storage device of claim 1, wherein the slot comprises a first slot portion separated from a second slot portion by a bridge.

16. The storage device of claim 15, wherein the bridge is aligned substantially parallel to a radius of the support element.

17. A rotatable storage device, comprising:
a frame assembly oriented substantially vertically;
a support element interconnected to the frame assembly, the support element comprising:
a top surface opposite a bottom surface; and
a slot formed through the support element and extending from the top surface through the bottom surface, the slot to receive at least one hook, wherein the slot includes a first slot portion separated from a second slot portion by a bridge, and wherein the slot is substantially parallel to an outer axial edge of the support element; and
an arrester interconnected to the frame assembly, the arrester positioned below the support element.

18. The rotatable storage device of claim 17, wherein an outer axial edge of the arrester has at least one notch.

19. The rotatable storage device of claim 17, wherein the slot comprises a lower portion positioned below an upper portion, the lower portion of the slot having a width that is less than a width of the upper portion of the slot.

20. The rotatable storage device of claim 19, wherein the slot further comprises two ledges formed by a transition from the wider upper portion of the slot to the narrower lower portion of the slot.
